(19) United States
(12) Patent Application Publication
(10) Pub. No.: US 2019/0001195 A1
(43) Pub. Date: Jan. 3, 2019

(54) MODIFIED ELASTIC GYM BALL

(71) Applicant: Shuo-Hsiu Johnny CHANG, Taipei City (TW)

(72) Inventor: Shuo-Hsiu Johnny CHANG, Taipei City (TW)

(21) Appl. No.: 15/807,079

(22) Filed: Nov. 8, 2017

(30) Foreign Application Priority Data
Jun. 30, 2017 (CN) 201720781483.2

(51) Int. Cl. A63B 43/00; A61H 15/00; A63B 41/00; A63B 47/00; A63B 45/00

(52) U.S. Cl. CPC A63B 43/002; A61H 15/00; A63B 41/00; A63B 47/00; A63B 45/00; A61H 2201/0103; A63B 2209/00; A61H 2201/0161; A61H 2201/1261; A61H 2201/1647; A61H 2201/1695; A63B 2210/50; A61H 2201/0157

(57) ABSTRACT

A modified elastic gym ball includes a hollow spherical body, a plurality of first polygonal column bumps and a plurality of second polygonal column bumps. The hollow spherical body has an outer surface. The plurality of first polygonal column bumps and the plurality of second polygonal column bumps are individually protruded from the outer surface by a first protrusive height and a second protrusive height different from the first protrusive height, respectively.

This application claims the benefit of China Patent Application Serial No. 201720781483.2, filed Jun. 30, 2017, the subject matter of which is incorporated herein by reference.

### BACKGROUND OF THE INVENTION

### 1. Field of the Invention

The invention relates to a gym ball, and more particularly to a modified elastic gym ball that includes externally a plurality of first polygonal column bumps and a plurality of second polygonal column bumps.

### 2. Description of the Prior Art

Recently, as the atmosphere of physical activity prevails, various merchandises related to sports, such as sports wears, accessory gears and other supplies, becomes more and more popular. A landmark in 2014 is that, at this year and since then, the annual sales volume of yoga pants has exceeded that of the jeans. Obviously, from the record in sales volume of the yoga pants, it is further ascertained and proclaims an era of sports.

Among various popular sports in the atmosphere of physical activity, yoga is one of the mainstream sports. To public understanding, the so-called yoga represents mainly a series of self-cultivation practices. It adopts some ancient but easy-to-master bodily postures, integrated with breath control, to shape up the users and improve the physical, psychological, sensational and spiritual abilities, so as to achieve a harmonic state of body and mind.

In order to help the user to undergo different yoga postures safely and peacefully, a loose and comfortable yoga pant, a protective yoga pad and a gym ball (or called as a Swiss ball) for facilitating difficult postures are usually required.

The gym ball, or called as a yoga ball or a rhythm ball, is an elastic yoga gear shaped as a spherical body for facilitating yoga practices, by which elastic contacts upon the belly, back, waist, legs and other body portions can be performed to have elastic protrusive bumps on an outer surface of the gym ball to massage the user, thereby to promote his/her blood circulation, and thus to relax corresponding muscles. Also, through practicing with the gym ball, body fats can be burned effectively, stress can be relieved substantially, mental concentration can be enhanced, and muscle endurance can be increased as well.

In the art, the conventional gym ball, structured to be a hollow spherical body, has a plurality of protrusive conical bumps on an outer surface of the hollow spherical body as a unique piece.

However, since the conical bump is usually shaped to have an acute tip, so while the conical bumps of the conventional gym ball contact the user, painfulness to some degree upon the users may be induced, due to each tiny contact area between the user and the conical bump. Such painfulness would fail to relax user's body completely. In addition, further move of the user instinctively to lessen the painfulness would distort the postures, thus expected functions from specific postures would be rarely achieved, and eventually possible sports injuries could be caused.

Furthermore, since the conical bump of the conventional gym ball has a sharp tip, thus the gym ball is hard to be fixed always in a stationary position while in storage. Namely, limited rolling in an arbitrary direction in the storage space would be expected. As a remedy thereto, an air plug of the gym ball would be pulled off to exhaust the internal air or fluid, such that the gym ball can be deflated for easy storage. Till the next usage, the gym ball should be firstly pumped to a desired size. Alternatively, a net bag might be also used as a storage means for the gym ball. After the gym ball is put into the net bag, the net bag can be then fixed onto a wall or a roof. Nevertheless, the aforesaid two storage means may be still less convenient to the user. Apparently, it might be deemed as a trivia to waste time and labors for a user to perform storing after each exercise.

### SUMMARY OF THE INVENTION

In view of the prior art described above, since the conventional gym ball is furnished with the conical bumps, painfulness to the user is highly possible, and thereby satisfied body relaxation would be impossible. Also, ill yoga postures would be expected due to a human instinct for lessening painfulness. Definitely, expected functions from practicing yoga would be away to be obtained, and even worse a risk in sports injuries might be inevitable. In addition, also because of the conical bumps of the conventional gym ball, the gym ball in storage would be hard to be positioned stationary, and arbitrary rolling of the gym ball within the storage room can be expected. Therefore, either the storage by deflating the gym ball or that by keeping inside the net bag (further fixed onto a wall or a roof) may waste time and labors of the user or related personnel, and will definitely cause inconvenience to some degree.

Accordingly, it is an object of the present invention to provide a modified elastic gym ball, which replaces the conventional conical bumps by modified polygonal column bumps. Since a contact area between each the polygonal column bump and the user is broader than that between the conventional conical bump and the user, so the forcing upon the user by the polygonal column bump would be in a distributed pattern, and thus the corresponding painfulness upon the user would be significantly reduced. In addition, since the gym ball of the present invention is furnished with the polygonal column bumps, and since a contact area between each the polygonal column bump and the ground is broader than that between the conventional conical bump and the ground, so the gym ball having the polygonal column bumps can provide larger friction on the ground, and thus, while in storage, it would be easier for the gym ball of the present invention to be settled stationary at a fixed location, than the conventional gym ball can do. Thereupon, the aforesaid storage problem for the gym ball can be well resolved.

In the present invention, a modified elastic gym ball includes a hollow spherical body having an outer surface, a plurality of first polygonal column bumps and a plurality of second polygonal column bumps. Each of the plurality of first polygonal column bumps is protruded from the outer surface by a first protrusive height, and each of the plurality of second polygonal column bumps is protruded from the outer surface by a second protrusive height different from the first protrusive height.

In one embodiment of the present invention, each of the first polygonal column bumps and the second polygonal column bumps is shaped to be a hexagonal column bump.

In one embodiment of the present invention, the first polygonal column bumps and the second polygonal column bumps are all protruded from the outer surface as a unique piece.

In one embodiment of the present invention, the first protrusive height of the first polygonal column bump is smaller than the second protrusive height of the second polygonal column bump.

In one embodiment of the present invention, the first protrusive height of the first polygonal column bump is between 1 mm and 8 mm

In one embodiment of the present invention, a difference between the first protrusive height of the first polygonal column bump and the second protrusive height of the second polygonal column bump is between 1 mm and 5 mm.

In one embodiment of the present invention, a number ratio of the first polygonal column bumps to the second polygonal column bumps is between 1:2 and 1:4.

In one embodiment of the present invention, the first polygonal column bumps and the second polygonal column bumps are evenly distributed over the outer surface.

As stated above, the modified elastic gym ball of the present invention includes a hollow spherical body having an outer surface, a plurality of first polygonal column bumps and a plurality of second polygonal column bumps. Each of the first polygonal column bumps is protruded from the outer surface by a first protrusive height, and each of the second polygonal column bumps is protruded from the outer surface by a second protrusive height different from the first protrusive height.

In comparison with the conventional gym ball having conical bumps, the modified elastic gym ball provided by the present invention includes a hollow spherical body, first polygonal column bumps and second polygonal column bumps. By having the first polygonal column bumps and the second polygonal column bumps to replace the conventional conical bumps, the aforesaid problem of the conical bumps of the conventional gym ball in inducing user's painfulness, failing to relax user's muscles, distorting user's postures, losing expected functions, and even leading to sports injuries would be substantially resolved. Also, by applying the modified elastic gym ball of the present invention, another aforesaid problem of the conical bumps of the conventional gym ball in storage that the conventional gym ball needs to be deflated in advance or to be kept inside the net bag before being hung to a wall or a roof is effectively resolved as well.

All these objects are achieved by the modified elastic gym ball described below.

### BRIEF DESCRIPTION OF THE DRAWINGS

The present invention will now be specified with reference to its preferred embodiment illustrated in the drawings, in which:

FIG. 1 is a schematically perspective view of a first embodiment of the modified elastic gym ball in accordance with the present invention;

FIG. 2 is a schematically enlarged view of area A of FIG. 1;

FIG. 3 is a schematically cross-sectional view of FIG. 2 along line B-B; and

FIG. 4 shows schematically another embodiment of FIG. 3.

### DESCRIPTION OF THE PREFERRED EMBODIMENT

The invention disclosed herein is directed to a modified elastic gym ball. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

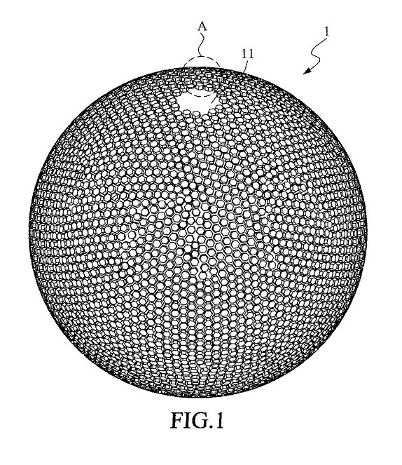

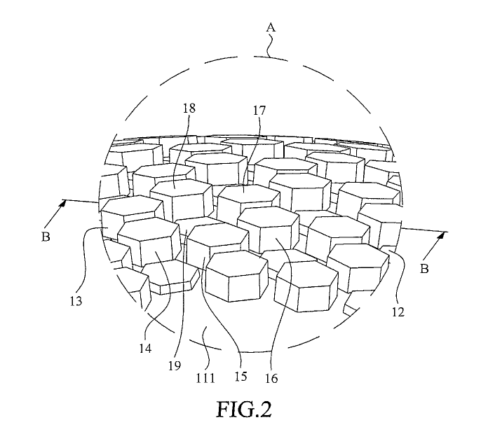

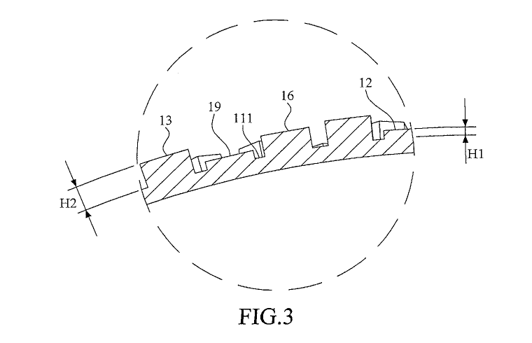

Refer now to FIG. 1 through FIG. 3; where FIG. 1 is a schematically perspective view of a first embodiment of the modified elastic gym ball in accordance with the present invention, FIG. 2 is a schematically enlarged view of area A of FIG. 1, and FIG. 3 is a schematically cross-sectional view of FIG. 2 along line B-B. As shown, the modified elastic gym ball 1 (the gym ball thereafter) is structured to have a hollow spherical body 11 having an outer surface 111, a plurality of first polygonal column bumps (12 and 19 in the figures) and a plurality of second polygonal column bumps (13, 14, 15, 16, 17 and 18 in the figures). Each of the first polygonal column bumps 19 are surrounded by six of the second polygonal column bumps 13, 14, 15, 16, 17 and 18.

In this embodiment, the hollow spherical body 11 can be made of an ABS (Acrylonitrile butadiene styrene) resin, which is a thermoplastic polymer material featured in high strength, satisfied toughness and good workability. Also, explosion-proof ability is further provided to the gym ball 1, by which the gym ball 1 would shrink inward, instead of exploding outward, upon being pierced by a sharp object. Thereupon, safety of the user can be ensured. Alternatively, the hollow spherical body 11 can be made of a PVC (Polyvinyl chloride) material or a TPE (Thermoplastic elastomer) material the like, so that the gym ball 1 can have sufficient elasticity and heavy load capacity. In addition, small explosion-proof bubbles can be added into the material for producing the hollow spherical body 11, such that the gym ball 1 could present considerable explosion-proof ability. Further, a pearl powder can be added into the material for producing the hollow spherical body 11, such that the outer surface 111 of the gym ball 1 can thus present smoothness and higher light reflectivity.

In addition, a diameter of the hollow spherical body 11 can be, but not limited to, 45 cm, 55 cm, 65 cm, 75 cm, or a proper scale according to specific users.

Though the first polygonal column bump 12 and the second polygonal column bump 13 of this embodiment are both structured to be respective hexagonal column bumps, yet they both can also be constructed to be cylindrical column bumps, triangular column bumps, quadrangular column bumps, or any other polygonal column bumps the like according to users' needs.

When the gym ball 1 of the present invention is applied, since the contact area between each of the first polygonal column bumps 12 and the second polygonal column bumps 13 and the user is broader than that between the aforesaid conventional conical bump and the user, so the forcing upon the user by the first polygonal column bump 12 or the second polygonal column bump 13 would present a distributed pattern, such that user's painfulness would be significantly reduced. Upon the reduced painfulness, the user can thus relax himself/herself completely while in exercising with the gym ball 1, also the spiritual concentration of the user can be enhanced, and thus various postures can be tried without body pain to obtain respective expected functions.

While the user applies the gym ball 1 to perform rolling, sitting up, lying down, or any the like, the first polygonal column bump 12 and/or the second polygonal column bump 13 would contact the user to proceed massage or stimulus upon the specific contact portion. Thereupon, specific muscle groups of the user can be stretched, and the blood circulation of the user can be promoted. Importantly, the application of the gym ball 1 provided by the present invention won't be accompanied by excessive pain that usually happens to the conventional gym ball having conical bumps, due that the contact area between each of the first polygonal column bumps 12 and the second polygonal column bumps 13 and the user is broader than that between the aforesaid conventional conical bump and the user.

In the present invention, when the gym ball 1 is to be stored after the user finishes his/her workout, since the contact area between each of the first polygonal column bumps 12 and the second polygonal column bumps 13 and the ground is broader than that between the aforesaid conventional conical bump and the ground, so the gym ball 1 of the present invention is much easier to be settled stationary without arbitrary rolling at a fixed location, than the conventional gym ball can do. Thereupon, the aforesaid storage problem for the gym ball can thus be resolved.

As shown, in this embodiment, the first polygonal column bump 12 protrudes from the outer surface 111 by a first protrusive height H1, and the second polygonal column bump 13 protrudes from the outer surface 111 by a second protrusive height H2 different from the first protrusive height H1.

Preferably, the first polygonal column bumps 12 and the second polygonal column bumps 13 are all protruded from the outer surface 111 as a unique piece, as shown in FIG 3. Alternatively, the first polygonal column bumps 12 and the second polygonal column bumps 13 can be fixed onto to the outer surface 111 by heat molding and then cold forming processes, or can be attached onto the outer surface 111 by firmly adhering.

In the present invention, a first protrusive height H1 of the first polygonal column bump 12 is smaller than a second protrusive height H2 of the second polygonal column bump 13. Preferably, the first protrusive height H1 can be between 1 mm and 8 mm, and a difference between the first protrusive height H1 and the second protrusive height H2 can be between 1 mm and 5 mm.

In addition, in this present invention, the first polygonal column bumps 12 and the second polygonal column bumps 13 are evenly distributed over the outer surface 111 of the gym ball 1, so as thereby to exert massage and stimulus regularly upon the user.

Preferably, a number ratio of the first polygonal column bumps 12 to the second polygonal column bumps 13 is between 1:2 and 1:4.

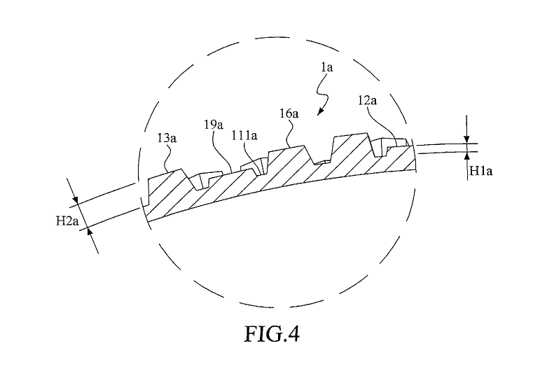

Referring now to FIG. 4, another embodiment of FIG. 3 is schematically shown. The modified elastic gym ball 1 (the gym ball thereafter) is structured to have a hollow spherical body (not labeled in the figure) having an outer surface 111a, a plurality of first polygonal column bumps (12a and 19a in the figure) and a plurality of second polygonal column bumps (13a and 16a in the figure).

In this embodiment, each of the first polygonal column bumps and the second polygonal column bumps is formed as a tapered polygonal column bump, namely a polygonal column bump with a sidewall thereof not perpendicular to a top surface thereof. In addition, the first polygonal column bump protrudes from the outer surface 111a by a first protrusive height H1a, and the second polygonal column bump protrudes from the outer surface 111a by a second protrusive height H2a different from the first protrusive height H1a. In this embodiment, the only difference thereof to the aforesaid embodiment shown from FIG. 1 to FIG. 3 is the construction of the first polygonal column bump and the second polygonal column bump, while the rest of elements in both embodiments are all formed identically.

In summary, since the conventional gym ball is furnished with the conical bumps, painfulness to the user is highly possible, and thereby satisfied body relaxation would be impossible. Also, ill yoga postures would be expected due to a human instinct for lessening painfulness. Definitely, expected functions from practicing yoga would be away to be obtained, and even worse a risk in sports injuries can be foreseen. In addition, also because of the conical bumps of the conventional gym ball, the gym ball in storage would be hard to be positioned stationary, and arbitrary rolling of the gym ball within the storage room can be expected. Therefore, either the storage by deflating the gym ball (and being inflated lately for the next usage) or that by keeping inside the net bag (further fixed onto a wall or a roof) may waste time and labors of the user or related personnel, and will definitely cause inconvenience to some degree.

By providing the modified elastic gym ball of the present invention to include a hollow spherical body having an outer surface, a plurality of first polygonal column bumps and a plurality of second polygonal column bumps, since a contact area between each the polygonal column bump and the user is broader than that between the conventional conical bump and the user, and further since a contact area between each the polygonal column bump and the ground is broader than that between the conventional conical bump and the ground, so the aforesaid problems in usage painfulness and storage rolling, caused by the conventional conical bumps, can be substantially resolved.

While the present invention has been particularly shown and described with reference to a preferred embodiment, it will be understood by those skilled in the art that various changes in form and detail may be without departing from the spirit and scope of the present invention.

What is claimed is:

1. A modified elastic gym ball, comprising:
a hollow spherical body, having an outer surface;
a plurality of first polygonal column bumps, protruding individually from the outer surface by a first protrusive height; and
a plurality of second polygonal column bumps, protruding individually from the outer surface by a second protrusive height different from the first protrusive height.

2. The modified elastic gym ball of claim 1, wherein each of the plurality of first polygonal column bumps and the plurality of second polygonal column bumps is shaped to be a hexagonal column bump.

3. The modified elastic gym ball of claim 1, wherein the plurality of first polygonal column bumps and the plurality of second polygonal column bumps are all protruded from the outer surface as a unique piece.

4. The modified elastic gym ball of claim 1, wherein the first protrusive height is smaller than the second protrusive height.

5. The modified elastic gym ball of claim 4, wherein the first protrusive height is between 1 mm and 8 mm

6. The modified elastic gym ball of claim 5, wherein a difference between the first protrusive height and the second protrusive height is between 1 mm and 5 mm.

7. The modified elastic gym ball of claim 1, wherein the plurality of first polygonal column bumps and the plurality of second polygonal column bumps are evenly distributed on the outer surface.

8. The modified elastic gym ball of claim 7, wherein a number ratio of the plurality of first polygonal column bumps to the plurality of second polygonal column bumps is between 1:2 and 1:4.
